(19) United States
(12) Patent Application Publication
(10) Pub. No.: US 2025/0198166 A1
(43) Pub. Date: Jun. 19, 2025

(54) Cladding System

(71) Applicant: Megasol Energie AG, Deitingen (CH)

(72) Inventor: Markus Gisler, Wangen an der Aare (CH)

(73) Assignee: Megasol Energie AG, Deitingen (CH)

(21) Appl. No.: 18/849,775

(22) PCT Filed: Mar. 24, 2023
(86) PCT No.: PCT/EP2023/057602

§ 371 Date: Sep. 23, 2024

(30) Foreign Application Priority Data
Mar. 29, 2022 (CH) CH000358/2022

(51) Int. Cl. E04F 13/08

(52) U.S. Cl. CPC E04F 13/083

(57) ABSTRACT

A cladding system according to the disclosure for cladding an outside of a building, in particular a roof and/or a facade, typically comprises at least two rails and at least one panel extending in a mounted position between the at least two rails. The at least one panel comprising two skirts each having a rim extending parallel to the backface and comprising a recess extending from the rim into the skirt. A displaceable latch comprises a locking tooth extending in the locked position into the recess forming an undercut. Each rail comprises an upward direction open channel for receiving in a mounted position two adjacent skirts of two laterally neighboring panels each extending between two neighboring rails. At least one bolt is arranged in and spanning across the channel configured to be in the mounted position of the panel arranged in the recess behind the locking tooth.

### CROSS-REFERENCE TO RELATED APPLICATIONS

This application is a U.S. National Phase Application that claims the benefit of the filing date of International PCT Application No. PCT/EP2023/057602, filed on Mar. 24, 2023, that claims priority to Swiss Application No. CH000358/2022, filed on Mar. 29, 2022, each of which are hereby incorporated by reference in their entirety.

### FIELD OF THE DISCLOSURE

The present disclosure relates to a cladding system for cladding an outside of a building, in particular a roof and/or a facade, and a panel suitable for such a cladding system.

### BACKGROUND OF THE DISCLOSURE

Known cladding systems typically comprise a support structure such as beams attachable to a structure on the outside of a building. Panels are fixed to the support structure in order to clad an outside of the building. Examples are solar panels arranged on a façade or a roof of a building.

Several attempts are known from the prior art to provide such cladding systems, which are briefly described hereinafter.

EP2527763A2 published in 2012 in the name of Markus Gisler (the applicant) relates to a cladding system comprising at least one structural element and at least two supporting elements for releasably fixing the at least one structural element on a substructure. The structural element comprising a frame, which frame has an upper profile, a lower profile and two lateral profiles, a lower profile and two lateral profiles. The supporting element has a longitudinal profile with at least one holding means and that the two lateral profiles of the frame each have on their outer wall a recess in which in each case one of the holding means engages for the releasable fixing of the component.

U.S. Pat. No. 10,113,317BA published in 2018 in the name of Gordon Sales Inc. relates to A wall and ceiling panel system which utilizes a concealed resilient beam for securing a panel to a wall or ceiling structure is disclosed. A wall and ceiling panel system having features of the present invention can comprise a panel configured for releasable attachment to a latching assembly. The latching assembly can comprise a resilient beam dynamically secured to a base bracket so as to allow the resilient beam to deflect relative to the base bracket during the panel installation and removal process. The panel can comprise a keyed flange having at least one locking slot configured to mate with the resilient beam, with the panel becoming secured to the latching assembly once the panel's key flange is mated with the resilient beam.

### SUMMARY OF THE DISCLOSURE

The known cladding systems typically require a lot of manual effort during installation or the panels are prone to disconnect unintentionally from the support structure. It is an object of the disclosure to provide a cladding system, which addresses at least one the above-mentioned or other disadvantages.

A cladding system according to the disclosure for cladding an outside of a building, in particular a roof and/or a facade, typically comprises at least two rails and at least one panel extending in a mounted position between the at least two rails. The at least two rails are usually configured to be attached to a structure of a building in parallel lines spaced a distance apart from each other. The at least one panel usually comprises two skirts extending from a backface of the panel at opposing sides in a downward direction. Each skirt typically has a rim extending parallel to the backface and comprises a recess extending from the rim into the skirt. A latch displaceable between a locked position and an unlocked position comprises a locking tooth extending in the locked position into the recess forming an undercut. The latch is typically arranged at the panel, in particular at the skirt(s) of the panel. Each rail comprises an in an upward direction open channel for receiving in a mounted position two adjacent skirts of two laterally neighboring panels each extending between two neighboring rails. To support the at least one panel in a mounted position, at least one bolt is arranged in and spanning across the channel configured to be in the mounted position of the panel arranged in the recess behind the locking tooth. Usually each rail comprises several bolts being arranged equidistant for mounting multiple panels next to each other in a direction of the fall line. The upward and downward direction can be understood as being essentially perpendicular to the general extension of the structure of the building onto which the cladding system is attachable. The fall line is generally parallel to the to the general extension of the structure of the building onto which the cladding system is attachable

For a good performance, the latch is displaceable from the locked position into the unlocked position against a force of a spring. In a preferred variation a base is attached each skirt, said base having a stop configured to limit a displacement of the respective latch along the skirt. The stop may define the unlocked position and/or the locked position of the latch along the skirt. If present, a spring is arranged between the base and the latch for displacing the latch from the unlocked position to the locked position. This allows the latch to be displaced from the unlocked position to the locked position by a restoring force of the spring without the need for manual intervention of the person mounting the panel.

To allow an easy latching, the locking tooth comprises a ramp facing the rim and being inclined thereto for engaging with the bolt and translating a movement of the bolt into the recess into a displacement the latch from the locked into the unlocked position. Compared to the prior art, this eliminates the effort of displacing the entire panel along the rails to lock it with the bolts. A panel according to the disclosure can be placed onto the rails, while the latch snaps in behind the bolt to secure the interconnection of the panel and the rails in an automatic manner.

Depending on the design, the latch is displaceable along the respective skirt essentially parallel to the rim. This allows a compact construction of the panel. For an easy installation, the recesses are arranged at a lower end of the panel in a mounted position, in particular in a lower third of the respective skirt.

For an easy construction, the latch is at least partially accommodated in the respective skirt forming a guide for the latch. Preferably, the skirts have an essentially U-shaped or C-shaped cross-section for at least partially encompassing the latch. In a preferred variation, the latch is laterally accessible for manually displacing the latch from the locked position into the unlocked position. In particular, the latch may comprise an engagement contour for engaging with a disassembly tool.

If appropriate the skirts are made from an extruded profile, in particular a metal profile.

Depending on the field of application, the latch is designed as an essentially planar part. Preferably, the latch is made from sheet metal. Alternatively, or in addition, the base can be made from sheet metal.

In some variations, the panel comprises an upper sealing extending in a mounted position along an upper end of the panel for forming a rainproof sealing with an upper neighboring panel. Alternatively, or in addition, the panel comprises a lower sealing extending in a mounted position along a lower end of the panel for forming a rainproof sealing with a lower neighboring panel. Good results as possible, when the lower sealing is configured to at least partially overlap with the upper sealing of a neighboring lower panel, or vice versa.

If present, the open channel of the rails may act as a drainage channel for draining rain water.

Another aspect of the disclosure is directed to a panel suitable for a cladding system as described above. The previously described embodiments of the cladding system disclose at the same time correspondingly designed embodiments of the panel and vice versa. Depending on the field of application, the panel can be a solar panel. For good performance the solar panel is in the mounted position spaced apart from the structure of the building by the rails to ensure ventilation therebetween.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings are showing:

FIG. 1 a perspective view of a first variation of a cladding system according to the disclosure;

FIG. 2 a detailed view of the first variation of FIG. 1 indicated by box A;

FIG. 3 a first variation of a panel according to the disclosure in a partially exploded view;

FIG. 4 a detailed view of the first variation of FIG. 3 indicated by box B;

FIG. 5 a panel of the first variation of FIG. 1 before interconnection;

FIG. 6 a panel of the first variation of FIG. 1 during interconnection; and

FIG. 7 an interconnected panel of the first variation of FIG. 1.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

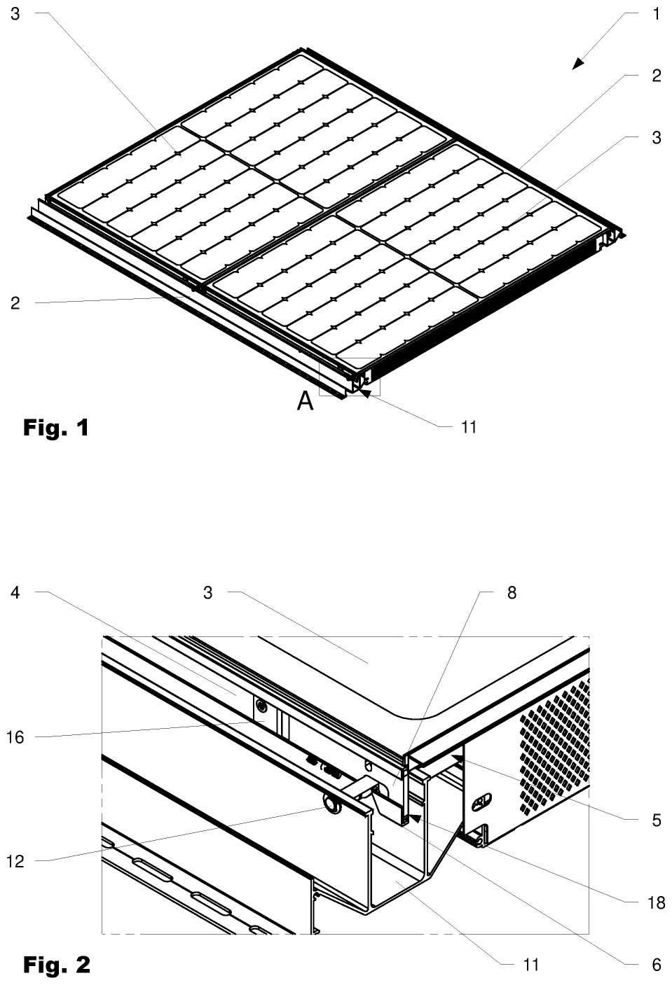

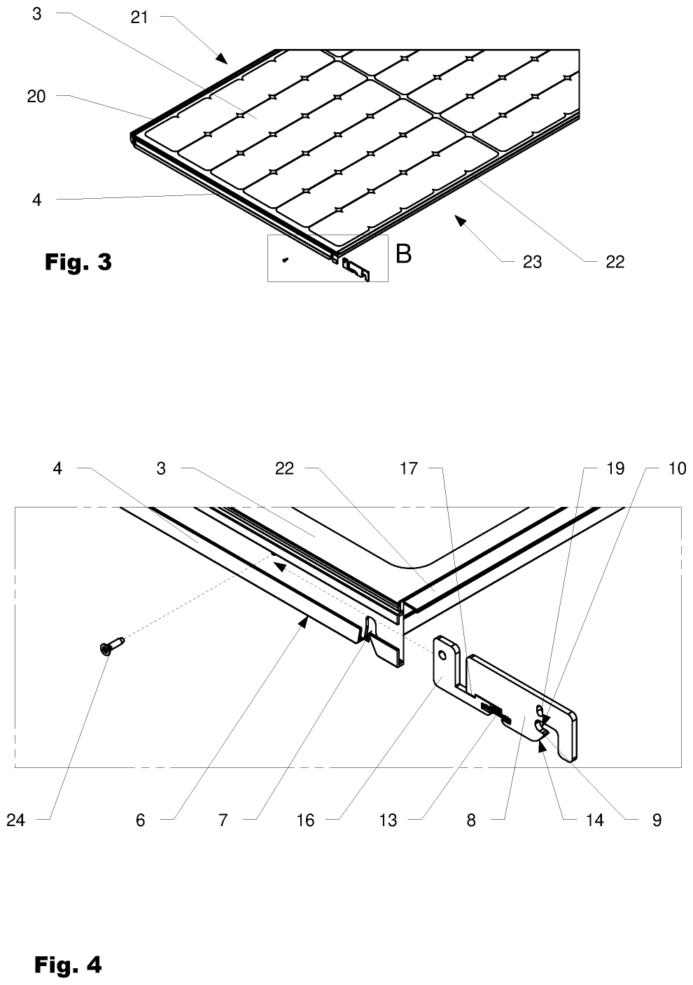

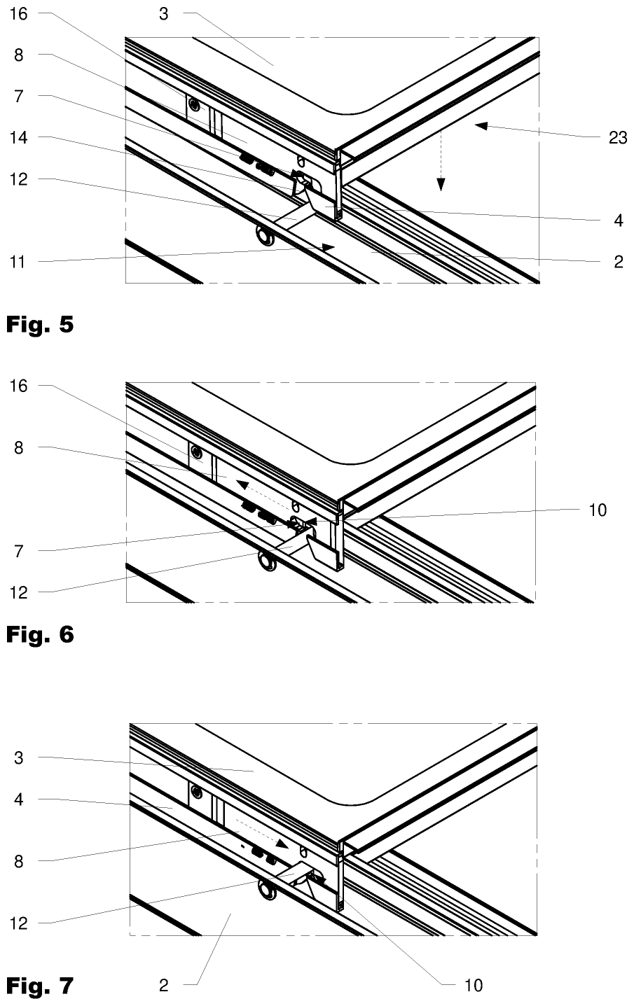

FIG. 1 shows perspective view of a first variation of a cladding system 1 according to the disclosure and FIG. 2 shows a detailed view of the first variation of FIG. 1 indicated by box A. In FIG. 3 a first variation of a panel 3 according to the disclosure in a partially exploded view is shown and in FIG. 4 a detailed view of the first variation of FIG. 3 indicated by box B can be seen. In FIGS. 5 to 7, the interconnection of the first variation of a panel 3 with a rail 2 is shown in three stages.

The first variation of the cladding system 1, as shown in FIGS. 1 and 2, comprises rails 2 and two panels 3 each extending in a mounted position between the rails 2. The rails 2 are typically attached to a structure, such as roof battens (not shown) or walls, of a building in parallel lines spaced a distance apart from each other. Each rail 2 comprises an in an upward direction open channel 11 for receiving in a mounted position two adjacent skirts 4 of two laterally neighboring panels 3 each extending between two neighboring rails 2. As best visible in FIG. 2, the at least one panel 2 comprises two skirts 4 extending from a backface 5 of the panel 3 at opposing sides in a downward direction. The backface 5 is typically facing in a mounted position towards the structure of the building (not shown). Each skirt 4 has a rim 6 extending parallel to the backface 5 and comprises a recess 7 extending from the rim 6 into the skirt 4. The recess 7 typically extends from the rim 6 in the upward direction towards the backface 5 of the panel 3. Arranged at the skirt 4 is a latch 8 displaceable between a locked position and an unlocked position. The latch 8 comprises a locking tooth 9 extending in the locked position into the recess 7 forming an undercut 10. In FIG. 2 the latch 8 is shown in the locked position. In the channel 11 a bolt 12 is arranged spanning across the channel 11. The bolt 12 is configured to be in the mounted position of the panel 3 arranged in the recess 7 behind the locking tooth 9. In the locking position the locking tooth 9 blocks the bolt 12 arranged in the recess 7 from disengaging with the recess 7. This way the panel 3 and the rails 2 are prevented from unintentional disconnection.

In the shown variation two bolts 12 are arranged per rails 2 to interconnect two panels 3 next to each other in the direction of the fall line.

As shown in FIGS. 3 and 4, the latch 8 is displaceable from the locked position into the unlocked position against a force of a spring 13. A base 16 is attached the skirt 4 by a screw 24. The base 16 is in direct contact with the latch 8 and provides a stop 17 to limit a displacement of the latch 8 along the skirt 4. The dashed lines indicate the assembly of the latch 8, the base 16 and the screw 24. In the shown variation the stop 17 of the base 16 engages with the latch 8, restricts the displacement thereof and thereby defines the locked and unlocked position. Arranged between the latch 8 and the base 16 is the spring 13 being compressed when the latch is displaced from the locked into the unlocked position. This way the spring 13 can exert a restoring force to displace the latch 8 from the unlocked position to the locked position, in particular once the bolt 12 is in the recess 7/undercut 10 behind the locking tooth 9.

The locking tooth 9, as best visible in FIG. 4, comprises a ramp 14 facing the rim 6. The ramp 14 is inclined with respect to the general extension of the rim 6 for engaging with the bolt 12 and translating a movement of the bolt 12 towards the undercut 10 into a displacement the latch 8 from the locked into the unlocked position, as shown in FIGS. 5 and 6.

Typically, the skirts 4 are made from an extruded metal profile. In the shown variation the skirts 4 have a C-shaped cross-section forming a guide 18 for the latch 8 to be displaceable therein. In addition, the C-shaped cross-section allows to partially encompass the latch 8, while a lateral access to the latch 8 ensured. As visible in FIG. 4, the latch 8 comprises an engagement contour 19 for engaging with a disassembly tool (not shown) to manually displace the latch 8 from the locked into the unlocked position. This is foreseen in case the panel 3 is to be dismounted from the rails 2.

The base 16 as well as the latch 8 are made from sheet metal to have a narrow cross-section and to fit into the guide 18 formed by the skirts 4, without resulting in a bulky skirt 4.

In FIGS. 1 and 3, it can be seen that the first variation of the panel 3 comprises an upper sealing 21 extending in a mounted position along an upper end 21 of the panel for forming a rainproof sealing with an upper neighboring panel 3. In addition, the panel 3 comprises a lower sealing 22 extending in a mounted position along a lower end 23 of the panel 3 for forming a rainproof sealing with a lower neighboring panel 3. The lower sealing 22 being configured to overlap with a corresponding upper sealing 23 and vice versa.

The upper sealing 21 can be a labyrinth sealing having a water channel leading into the channel 11 of the rails 2 acting as a drainage channel 11 for draining atmospheric water.

Three stages of the panel 3 being interconnected to the rails is shown in FIGS. 5 to 7. In FIG. 5, the panel 3 is moved with its lower end 23 in a downward direction (indicated by the dashed arrow). The bolt 12 spanning the channel 11 of the rail 2 will contact the ramp 14 of the locking tooth 9. In FIG. 6, the panel 3 is moved further towards the rail 2 with its downward end 23. The bolt 12 has displaced the latch 8 via the ramp 14 arranged at its locking tooth 9 from the locked position into the unlocked position (indicated by the dashed arrow). In this state the spring 13 (not visible) is compressed by the latch 8 against the base 16. In FIG. 7, again the panel 3 is moved with its downward end 23 further towards the rail 2 and into the mounted position. The bolt 12 has moved past the locking tooth 9 into the undercut 10/recess 7. The spring 13 (not shown) has displaced the latch 8 back into the locked position, where it is secured by the stop 17 of the base 16.

Rather, the words used in the specification are words of description rather than limitation, and it is understood that various changes may be made without departing from the scope of the disclosure.

LIST OF DESIGNATIONS

| | | | |
|---|---|---|---|
| 1 | Cladding system | 13 | Spring |
| 2 | Rail | 14 | Ramp (locking tooth) |
| 3 | Panel | 15 | Lower end (panel) |
| 4 | Skirt | 16 | Base |
| 5 | Backface | 17 | Stop (base) |
| 6 | Rim | 18 | Guide (skirt) |
| 7 | Recess | 19 | Engagement contour |
| 8 | Latch | 20 | Upper sealing |
| 9 | Locking tooth | 21 | Upper end |
| 10 | Undercut | 22 | Lower sealing |
| 11 | Channel | 23 | Lower end |
| 12 | Bolt | 24 | Screw |

1. A cladding system for cladding an outside of a building, in particular a roof and/or a facade, the cladding system comprising:
a. at least two rails configured to be attached to a structure of a building in parallel lines spaced a distance apart from each other;
b. at least one panel comprising two skirts extending from a backface of the panel at opposing sides in a downward direction, each skirt having a rim extending parallel to the backface and comprising a recess extending from the rim into the skirt;
c. a latch displaceable between a locked position and an unlocked position comprising a locking tooth extending in the locked position into the recess forming an undercut;
d. each rail comprising an upward direction open channel for receiving in a mounted position two adjacent skirts of two laterally neighboring panels each extending between two neighboring rails; and
e. at least one bolt arranged in and spanning across the channel configured to be in the mounted position of the panel arranged in the recess behind the locking tooth.

2. The cladding system according to claim 1, wherein the latch is displaceable from the locked position into the unlocked position against a force of a spring.

3. The cladding system according to claim 1, wherein the locking tooth comprises a ramp facing the rim and being inclined thereto for engaging with the bolt and translating a movement of the bolt into the recess into a displacement of the latch from the locked position into the unlocked position.

4. The cladding system according to claim 1, wherein the latch is displaceable along the respective skirt essentially parallel to the rim.

5. The cladding system according to claim 1, wherein the recesses are arranged at a lower end of the panel in a mounted position, in particular in a lower third of the respective skirt.

6. The cladding system according to claim 1, wherein a base is attached to each skirt, the base having a stop configured to limit a displacement of the respective latch along the skirt.

7. The cladding system according to claim 6, wherein a spring is arranged between the base and the latch for displacing the latch from the unlocked position to the locked position.

8. The cladding system according to claim 1, wherein the latch is at least partially accommodated in the respective skirt forming a guide for the latch.

9. The cladding system according to claim 1, wherein the skirts have an essentially U-shaped or C-shaped cross-section for at least partially encompassing the latch.

10. The cladding system according to claim 1, wherein the latch is laterally accessible for manually displacing the latch from the locked position into the unlocked position.

11. The cladding system according to claim 10, wherein the latch comprises an engagement contour for engaging with a disassembly tool.

12. The cladding system according to claim 1, wherein the latch is made from sheet metal.

13. The cladding system according to claim 1, wherein the panel comprises an upper sealing extending in a mounted position along an upper end of the panel for forming a rainproof sealing with an upper neighboring panel.

14. The cladding system according to claim 1, wherein the panel comprises a lower sealing extending in a mounted position along a lower end of the panel for forming a rainproof sealing with a lower neighboring panel.

15. The cladding system according to claim 1, wherein the open channel of the rails acts as a drainage channel for draining rain water.

16. A panel suitable for the cladding system according to claim 1.
